(19) United States
(12) Patent Application Publication
(10) Pub. No.: US 2010/0052553 A1
(43) Pub. Date: Mar. 4, 2010

(54) Control of Lamp Striking Voltage and Recovery of Energy From Resonant Lamp Strike Circuits Used for Electronic High Intensity Discharge Lamp Ballasting and Other Lamp Ballasts

(75) Inventors: Stephen Soar, Lancashire (GB); Simon Richard Greenwood, Altrincham (GB)

Correspondence Address: REINHART BOERNER VAN DEUREN P.C., 2215 PERRYGREEN WAY, ROCKFORD, IL, 61107, US

(73) Assignee: GREENWOOD SOAR IP LIMITED, Lancashire (GB)

(21) Appl. No.: 12/549,432

(22) Filed: Aug. 28, 2009

Related U.S. Application Data
(60) Provisional application No. 61/093,166, filed on Aug. 29, 2008.

(51) Int. Cl. H05B 41/24

(52) U.S. Cl. 315/209 T

(57) ABSTRACT

A system for controlling lamp striking voltage and recovery of energy from resonant lamp strike circuits used for electronic high intensity discharge lamp ballasting and other lamp ballasts is provided.

### CROSS-REFERENCE TO RELATED PATENT APPLICATION

This patent application claims the benefit of U.S. Provisional Patent Application No. 61/093,166, filed Aug. 29, 2008, the entire teachings and disclosure of which are incorporated herein by reference thereto.

### FIELD OF THE INVENTION

The present invention relates to resonant lamp strike circuits. More particularly, the present invention relates to control of lamp striking voltage and recovery of energy from resonant lamp strike circuits.

### BACKGROUND OF THE INVENTION

In recent years Electronic High Intensity Discharge Lamp Ballasts have taken over from the traditional copper wire winding and iron core “magnetic” or reactive ballasts in combination with a high voltage pulse ignitor. Most recently these Electronic High Intensity Discharge Lamp Ballasts have used resonant high frequency ignition to break down and ionise the gas filling of the discharge tube. These resonant high frequency ignition systems have some advantages over earlier pulse ignition systems in that most lamps will break down at a lower voltage with high frequency than with discrete short pulses of high voltage. There are considerations of various standards which limit the voltage of pulse and resonant ignition systems and in some cases there are lamp manufacturer imposed minimum and maximum strike voltage limits which have to be met.

In resonant high frequency ignition systems, typically the voltage for striking the lamp is provided by a resonant L & C circuit driven by a square wave voltage provided by the ballast's output stage. FIG. 1 shows such a circuit which may be used to provide resonant striking by means of resonating a capacitor and inductor to multiply a stimulating voltage.

A stimulating voltage 6 is provided by switching means 4 and 5 which are controlled to turn on and off in opposition and in response to gate signals provided by controller circuit 1. The stimulating voltage 6 is resultant of the alternate switching of the node of switching means 4 and 5 and inductor 7 alternately connecting the inductor 7 to a first positive DC voltage rail 2 and a second negative DC voltage rail 3. The controller circuit 1 may be designed or programmed to operate the switching means 4 and 5 at a frequency chosen to coincide with the resonant frequency of the inductor 7 and capacitor 8. Typically this resonant circuit comprising inductor 7 and the capacitor 8 is designed such that the Q factor of the circuit acts to give multiplication of the stimulating voltage 6 resulting in a lamp striking voltage 9 which may be limited in value by the Q factor of the circuit or the saturation of the magnetic core of the inductor 7. The control circuit 1 may be designed or programmed to operate the switching means 4 and 5 at various discrete frequencies within a range or to sweep the frequency between two frequencies so as to allow for manufacturing tolerances in the resonant components 7 and 8 and/or externally connected parasitic capacitances such as lamp wiring capacitance if the lamp 10 is wired some distance from the ballasting/striking circuit as shown. Once the lamp is struck, lamp arc current is maintained and conducted back to the DC voltage rails 2 and 3 via series connected capacitors 11 and 12.

Such circuits and means described in respect of FIG. 1 are prone to problems controlling the strike voltage accurately so as to meet the requirements of various regulatory bodies, standards and lamp manufacturers in respect of minimum and maximum strike voltage requirements. Tolerances in the resonant L and C components 7 and 8, differences in the magnetic material of the resonant inductor 7 due to manufacturing tolerances, changes in the magnetic material over a range of operating temperatures, externally connected parasitic capacitance, tolerance on the stimulating voltage frequency, etc. may all result in changes from the designed and desired lamp striking voltage.

Various other resonant striking circuits have been used. Usually these comprise resonant L and C components or multiplicities of the same. Whatever combinations are used there remains the problem of gaining accurate control of the lamp striking voltage without causing severe power losses or degrading of other lamp ballast circuit performance parameters.

The present invention provides improvements over the current state of the art.

### BRIEF SUMMARY OF THE INVENTION

In one aspect, embodiments of the current invention provide a circuit including means for providing resonant striking. The means for resonant striking include means for resonating a capacitor and an inductor to multiply a stimulating voltage. Also included are means for limiting the striking voltage, including a secondary winding and at least one pair of diodes.

In another aspect, a method for controlling a lamp striking circuit is provided. The method includes providing a secondary winding and at least one pair of diodes coupled in series between two voltage rails. One end of the secondary winding is coupled between a pair of capacitors with the capacitors coupled in series between the voltage rails, while the other end is coupled between the diodes. The voltage on the secondary winding is proportion to the voltage of the inductor included in the lamp striking circuit.

In another aspect, an embodiment of the present invention allows for excess voltage from occurring in a lamp striking circuit by diverting excess energy from a resonant circuit if the voltage exceeds a desired value. In another aspect, an embodiment of the present invention allows for substantial recovery of this excess voltage such that the excess energy is not lost.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

The components and the figures are not necessarily representative of any product or circuit used or not, emphasis instead being placed upon illustrating the principles of the invention. Moreover, in the figures, like reference numerals designate corresponding parts throughout the different views.

FIG. 1 shows a typical prior art circuit which may be used to provide resonant striking by means of resonating a capacitor and inductor to multiply a stimulating voltage.

FIG. 2 shows a first embodiment of a circuit which may be used to provide resonant striking, by means of resonating a capacitor and inductor to multiply a stimulating voltage, where the lamp striking voltage is limited by means of a secondary winding and a pair of diodes.

FIG. 3 shows a similar circuit to FIG. 1 with the addition of an L C low pass filter to reduce high frequency ripple current on the lamp during operation subsequent to striking of the lamp.

FIG. 4 shows a similar circuit to FIG. 1 with the addition of dual buck converters and L and C low pass filters to reduce high frequency ripple current on the lamp during operation subsequent to striking of the lamp.

FIG. 5 shows a second embodiment of a circuit which may be used to provide resonant striking by means of resonating a capacitor and inductor to multiply a stimulating voltage, where the lamp striking voltage is limited by means of a secondary winding and a pair of diodes.

FIG. 6 shows a similar circuit to FIG. 5 with the addition of an L C low pass filter to reduce high frequency ripple current on the lamp during operation subsequent to striking of the lamp.

FIG. 7 shows a similar circuit to FIG. 5 with the addition of dual buck converters and L and C low pass filters to reduce high frequency ripple current on the lamp during operation subsequent to striking of the lamp.

FIG. 8 shows a block diagram of a typical high intensity discharge lamp ballast using an output circuit similar to that in FIG. 7.

FIG. 9 shows an alternate embodiment of a circuit using a full bridge ballast which may be used to provide resonant striking by means of resonating a capacitor and inductor to multiply a stimulating voltage, where the lamp striking voltage is limited by means of a secondary winding and two pairs of diodes.

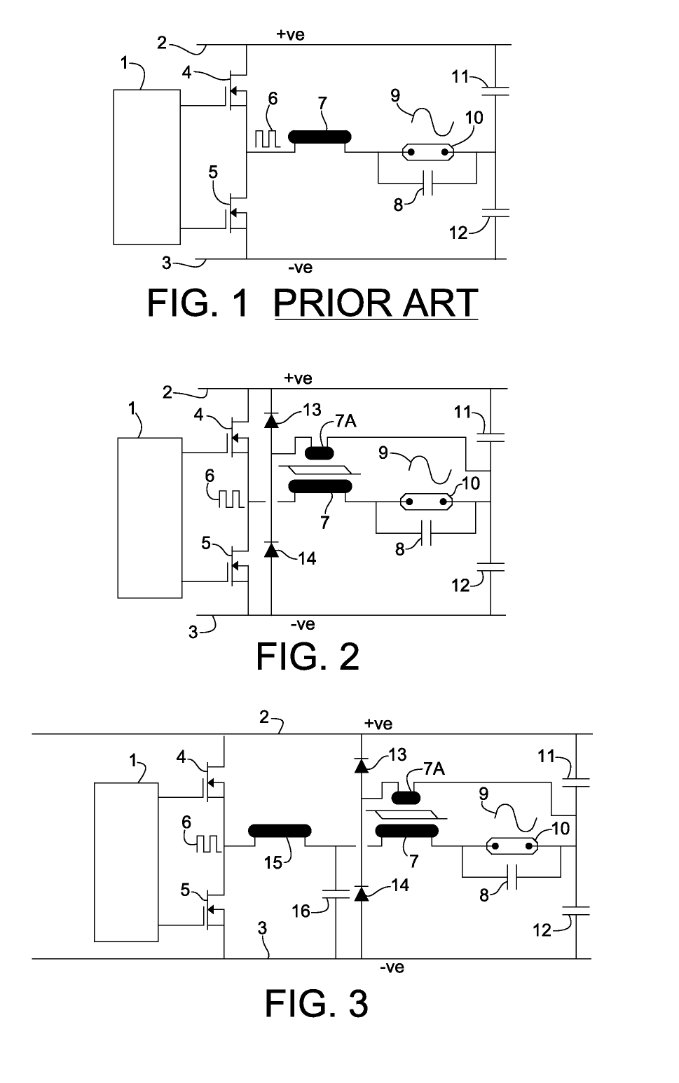

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

In a first preferred embodiment shown in FIG. 2, a circuit which may be used to provide resonant striking by means of resonating a capacitor and inductor to multiply a stimulating voltage is shown.

A stimulating voltage 6 is provided by switching means 4 and 5 which are controlled to turn on and off in opposition and in response to gate signals provided by controller circuit 1. The stimulating voltage 6 is resultant of the alternate switching of the node of switching means 4 and 5 and inductor 7 alternately connecting the inductor 7 to a first positive DC voltage rail 2 and a second negative DC voltage rail 3. The controller circuit 1 is designed or programmed to operate the switching means 4 and 5 at a frequency or several frequencies chosen to coincide with the resonant frequency of the inductor 7 and capacitor 8. In this case, a secondary winding 7A is provided which is connected in one instance to the mid node of the serially connected capacitors 11 and 12 and in the other instance to the junction of the two serially connected diodes 13 and 14. Additionally, a second pair of diodes (not shown) may be utilized in parallel with capacitors 11 and 12. The voltage in both windings of inductor 7 is substantially defined by the turns ratio of the windings. During the high frequency operation of the switching means the mid node of capacitors 11 and 12 remains substantially at the mid voltage between the +ve DC rail 2 and the −ve DC rail 3. High frequency voltage 9 intended for striking the lamp 10 is transformed by the turns ratio of the two windings on the inductor 7 so that a proportional voltage appears on the secondary winding 7A of inductor 7. The turns ratio of the inductor 7 is chosen such that at the desired peak lamp striking voltage, the peak secondary winding 7A voltage is equal to half of the DC rail voltage. Since one end of the secondary winding 7A is held at mid rail voltage at the mid node of the capacitors 11 and 12, the voltage at the opposing end of the secondary winding will forward bias either one of the diodes 13 and 14 if the peak secondary voltage exceeds the half rail voltage. By these means, excess voltage is prevented from occurring in the lamp striking circuit by diverting energy from the resonant circuit if the voltage exceeds the desired value. This energy is substantially recovered into the DC voltage rails such that the limiting of voltage does not result in increased losses.

In FIG. 3, a modified circuit is shown which uses a primary low pass filter comprising inductor 15 and capacitor 16. This additional low pass filter is used to reduce the high frequency current ripple applied to the lamp during normal low frequency square wave operation of the ballast circuit. The operation of the striking voltage control circuit is as described in reference to FIG. 2.

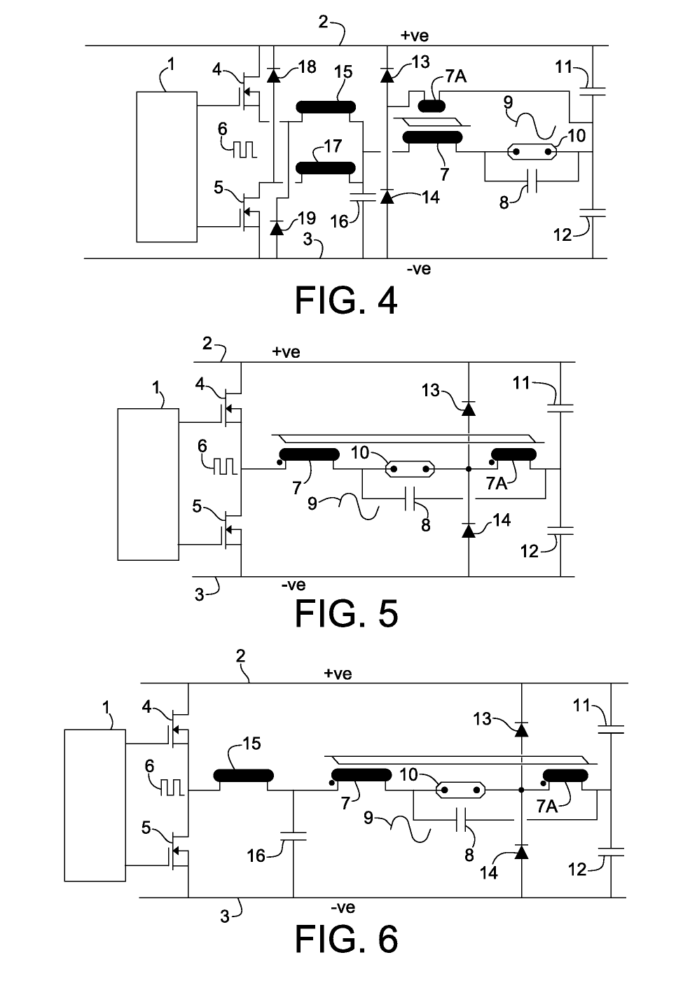

In FIG. 4, a modified circuit is shown which uses two buck converters/primary low pass filters each comprising an inductor 15 or 17 and capacitor 16. This additional low pass filter is used to reduce the high frequency current ripple applied to the lamp during normal low frequency square wave operation of the ballast circuit. The operation of the striking voltage control circuit is as described in reference to FIG. 2.

Other combinations and interconnections of inductors, capacitors, switching means and rectifying elements are possible and the arrangements shown here are in no way intended to limit the scope of the invention.

In a second preferred embodiment shown in FIG. 5, a circuit which may be used to provide resonant striking by means of resonating a capacitor and inductor to multiply a stimulating voltage is shown.

A stimulating voltage 6 is provided by switching means 4 and 5 which are controlled to turn off and on in opposition in response to gate signals provided by controller circuit 1. The stimulating voltage 6 is resultant of the alternate switching of the node of switching means 4 and 5 and inductor 7 alternately connecting the inductor 7 to a first positive DC voltage rail 2 and a second negative DC voltage rail 3. The controller circuit 1 is designed or programmed to operate the switching means 4 and 5 at a frequency or several frequencies chosen to coincide with the resonant frequency of the inductor 7 and capacitor 8. In this case, a secondary winding 7A is provided which is connected in one instance to the mid node of the serially connected capacitors 11 and 12 and in the other instance to the node of the two serially connected diodes 13 and 14 and lamp 10. The voltage in both windings of inductor 7 is substantially defined by the turns ratio of the windings. During the high frequency operation of the switching means, the mid node of capacitors 11 and 12 remains substantially at the mid voltage between the +ve DC rail 2 and the −ve DC rail 3. High frequency voltage 9 intended for striking the lamp 10 is transformed by the turns ratio of the two windings on the inductor 7 so that a proportional voltage appears on the secondary winding 7A of inductor 7. The turns ratio of the inductor 7 is chosen such that at the desired peak lamp striking voltage, the peak secondary winding 7A voltage is equal to half of the DC rail voltage. Since one end of the secondary winding 7A is held at mid rail voltage at the mid node of the capacitors 11 and 12, the voltage at the opposing end of the secondary winding will forward bias either one of the diodes 13 and 14 if the peak secondary voltage exceeds the half rail voltage. By these means, excess voltage is prevented from occurring in the lamp striking circuit by diverting energy from the resonant circuit if the voltage exceeds the desired value. This energy is substantially recovered into the DC voltage rails such that the limiting of voltage does not result in increased losses.

In FIG. 6, a modified circuit is shown which uses a primary low pass filter comprising inductor 15 and capacitor 16. This additional low pass filter is used to reduce the high frequency current ripple applied to the lamp during normal low frequency square wave operation. The operation of the striking voltage control circuit is as described in reference to FIG. 5.

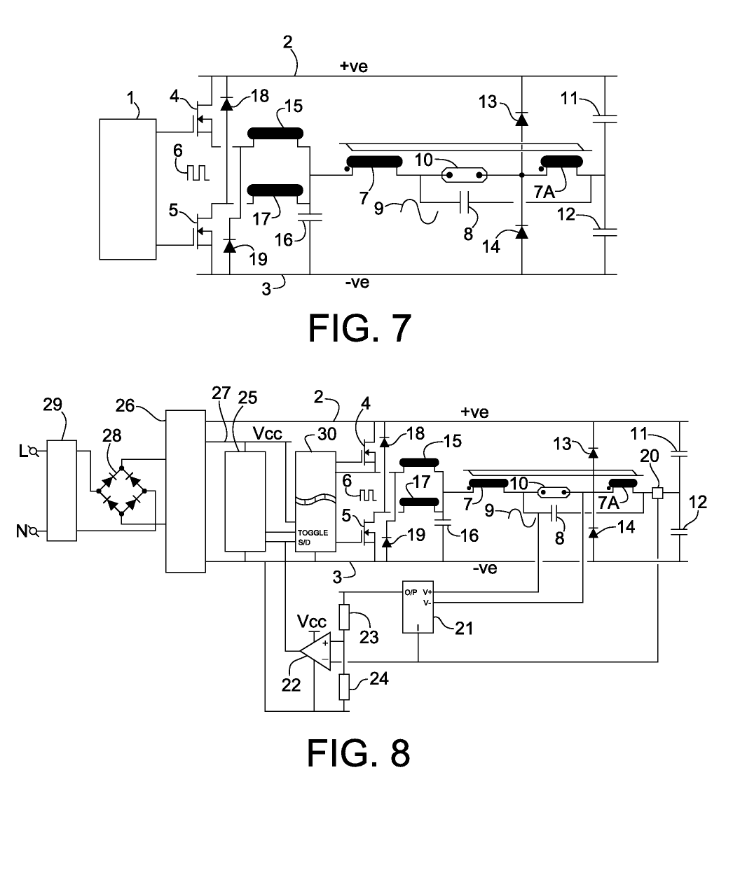

In FIG. 7, a modified circuit is shown which uses two buck converters/primary low pass filters each comprising an inductor 15 or 17 and capacitor 16. This additional low pass filter is used to reduce the high frequency current ripple applied to the lamp during normal low frequency square wave operation. The operation of the striking voltage control circuit is as described in reference to FIG. 5.

Other combinations, interconnections and topologies of inductors, capacitors, switching means and rectifying elements are possible and the arrangements shown here are in no way intended to limit the scope of the invention.

In FIG. 8, a partial block diagram of a typical high intensity discharge lamp ballast is shown. Mains terminals connect the mains input to an electromagnetic interference filter 29 which comprises inductive and capacitive elements such as to allow the reduction of conducted electrical interference generated within the ballast to be suppressed according to standards and regulations in force. 28 is a bridge rectifier circuit typically comprising four diodes which act upon the incoming mains AC voltage to rectify the voltage to a DC voltage. 26 is a power factor controller and power supply circuit which boosts the half sine DC voltage from the output of the rectifier circuit to a DC voltage suitable for the ballast output circuit. This DC voltage appears on DC Voltage rails 2 and 3. The capacitors 11 and 12 serve to smooth the voltage and store energy during the mains voltage zero crossing events. A third voltage rail is provided which is intended to supply the low voltage electronics circuits of the ballast at typically 15V DC. 25 is a micro controller or other control circuit which oversees the operation of the ballast and controls and monitors the striking of the lamp and operation of the lamp. Typically, there are two discrete modes of operation of the lamp.

In a first discrete mode of operation, the ballast output switching means 4 and 5 are alternately switched on and off at one or several different high frequencies, typically although not exclusively, in the range 40 kHz to 400 kHz by the action of the microcontroller 25 in response to a stored program, in order to stimulate resonance in the L C resonant circuit comprising inductor 7 and capacitor 8 and thereby generate sufficient voltage to breakdown or ionise the gas filling of the arc tube in a connected lamp 10.

Once the lamp has been broken down by the generated high voltage, the arc in the lamp's arc tube is maintained by the high frequency voltage applied to the inductor and capacitor network comprising inductors 15, 17 and 7 and the capacitors 16 and 8. Lamp current is returned to the voltage rails 2 and 3 via inductor winding 7A, current monitoring device 20 and capacitors 11 and 12. The impedance of the various reactive components 15, 17, 7, 16 and 8 and the operating frequency of the switching means 4 and 5 serve to control the current in the lamp during this first discrete mode of operation.

In a second discrete mode of operation, ballast output switching means 4 and 5 are alternately switched on and off at low frequency typically, although not exclusively, in the range 20 Hz to 400 Hz by the action of microcontroller 25 in response to a stored program. During each low frequency half cycle of operation relating to the programmed on time of each switching means, the current in the lamp circuit is monitored by current monitoring device 20 and a current proportional voltage signal is compared with a reference voltage signal at the node of resistors 23 and 24. If the current proportional voltage signal exceeds the reference voltage signal, the comparator 22 applies a shutdown signal to the switching means driver 30. This shutdown signal terminates or interrupts the on time of the active switching mean, switching the switching means off, until the lamp current proportional voltage signal falls below the reference voltage value at the node of resistors 23 and 24 causing the comparator 22 to remove the shutdown signal from the input of the switching means driver 30 which causes the driver to turn on the active switching means once again. This turning on and off of the switching means in response to the lamp current signal causes the lamp current to oscillate around the value set by the reference voltage signal at the node of resistors 23 and 24. The reference voltage value at the node of resistors 23 and 24 is also responsive to the output of lamp current and voltage multiplier and integrator 21 such that once the product of lamp voltage and current exceeds the lamp power desired the output of the multiplier and integrator 21 ramps down reducing the voltage reference signal at the node of resistors 23 and 24 thus reducing the lamp current responsive voltage signal and therefore the value of lamp current at which the active switching means is switched off, until the desired lamp power is achieved and controlled in response to the multiplier and integrator 21.

In the following, opposite low frequency half cycle relating to the programmed on time of each switching means, the current in the lamp circuit is monitored by current monitoring device 20 and a current proportional voltage signal is compared with a reference voltage signal at the node of resistors 23 and 24. If the current proportional voltage signal, exceeds the reference voltage signal the comparator 22 applies a shutdown signal to the switching means driver 30. This shutdown signal terminates or interrupts the on time of the active switching mean, switching the switching means off, until the lamp current proportional voltage signal falls below the reference voltage value at the node of resistors 23 and 24 causing the comparator 22 to remove the shutdown signal from the input of the switching means driver 30 which causes the driver to turn on the active switching means once again. This turning on and off of the switching means in response to the lamp current signal causes the lamp current to oscillate around the value set by the reference voltage signal at the node of resistors 23 and 24. The reference voltage value at the node of resistors 23 and 24 is also responsive to the output of lamp current and voltage multiplier and integrator 21 such that once the product of lamp voltage and current exceeds the lamp power desired the output of the multiplier and integrator 21 ramps down reducing the voltage reference signal at the node of resistors 23 and 24 thus reducing the lamp current responsive voltage signal and therefore the value of lamp current at which the active switching means is switched off, until the desired lamp power is achieved and controlled in response to the multiplier and integrator 21.

Thus, a low frequency square wave of alternating current is applied to the lamp with a small, superimposed, high frequency ripple current which is limited and bypassed by the various inductors and capacitors in the connected ballast circuit.

Other combinations, interconnections and topologies of inductors, capacitors, switching means and rectifying elements are possible and the arrangements shown here are in no way intended to limit the scope of the invention.

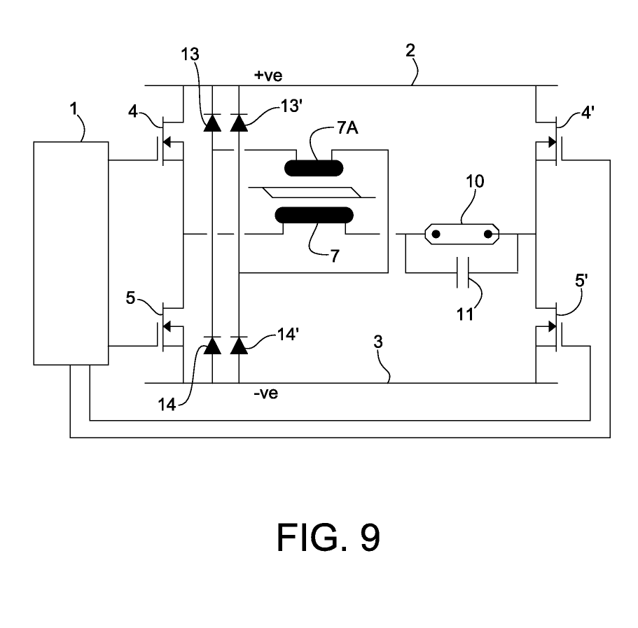

Other ballasting circuits are possible using, for instance a full bridge ballast output circuit shown in FIG. 9 with 4 switching elements, e.g. transistors 4, 5, 4′ and 5′ where the operation of 1 or 2 or more than 2 switching means is under the control of a control means. As may be seen in this FIG. 9, a second pair of diodes 13′ and 14′ are coupled to the opposite end of secondary winding 7A. In this embodiment, no capacitors (similar to capacitors 11, 12 in FIG. 2) are used to return the lamp current to the rails 2, 3. As such, there is no capacitor mid-point to which to return a second winding 7A. In this absence the second pair of diodes 13′ and 14′ are utilized.

Other ballasting means are possible where the lamp is operated at high frequency continuously after ionisation of the gas filling of the arc tube and no low frequency square wave mode of operation follows.

The scope of the invention is not limited to ballasting means, embodiments and methodologies described herein.

The scope of the invention is not limited to ballasting of high intensity discharge lamps.

All references, including publications, patent applications, and patents cited herein are hereby incorporated by reference to the same extent as if each reference were individually and specifically indicated to be incorporated by reference and were set forth in its entirety herein.

For purposes of this disclosure, the term “coupled” means the mechanical or electrical joining of two components directly or indirectly to one another. Such joining may be stationary in nature or moveable in nature. Such joining may be achieved with the two components and any additional intermediate members being integrally formed as a single unitary body with one another or the two components and any such additional member being attached to one another. Such adjoining may be permanent in nature or alternatively be removable or releasable in nature.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A circuit comprising:
means for providing resonant striking, the means for providing resonant striking including means for resonating a capacitor and an inductor to multiply a stimulating voltage; and
means for limiting the lamp striking voltage including a secondary winding and a pair of diodes.

2. The circuit of claim 1, wherein the means for resonating the capacitor and the inductor further comprises:
a first positive voltage rail and a second negative voltage rail;
a pair of switches connected in series between the voltage rails, defining a stimulating voltage node therebetween;
the inductor being coupled to the stimulating voltage node and to the capacitor, the capacitor being configured in parallel with a first and a second lamp terminals; and
wherein the means for limiting the lamp striking voltage comprises:
the first diode and the second diode being connected in series between the voltage rails;
a first node being defined between the first and second diodes;
the secondary winding further comprising a first end and a second end;
wherein the first end of the secondary winding is coupled to a second node held at a reference voltage; and
wherein the second end of the secondary winding is coupled to the first node between the first and second diodes.

3. The circuit of claim 2, wherein the second lamp terminal is coupled to the first node.

4. The circuit of claim 2, further comprising a first low pass filter and a second low pass filter, the first low pass filter configured to filter voltage from the first positive voltage rail before the voltage from the first positive voltage rail reaches the inductor and the capacitor, and the second low pass filter configured to filter a voltage from the second negative voltage rail before the voltage from the second negative voltage rail reaches the inductor and the capacitor.

5. The circuit of claim 2, wherein a voltage on the secondary winding will forward bias one of the first and second diodes if the voltage on the secondary winding exceeds the reference voltage.

6. The circuit of claim 3, further comprising a primary low pass filter configured to filter the stimulating voltage before the stimulating voltage is multiplied.

7. The circuit of claim 3, further comprising a first low pass filter and a second low pass filter, the first low pass filter configured to filter voltage from the first positive voltage rail prior to the inductor and the capacitor multiplying the voltage from the first positive voltage rail, and the second low pass filter configured to filter voltage from the second negative voltage rail prior to the inductor and the capacitor multiplying the voltage from the second negative voltage rail.

8. The circuit of claim 3, further comprising a monitoring device coupled to the secondary winding, the monitoring device configured to stop the stimulating voltage from reaching the inductor and the capacitor if a voltage of the secondary winding exceeds a second reference voltage.

9. The circuit of claim 1, further comprising a primary low pass filter configured to filter the stimulating voltage before the stimulating voltage is multiplied by the inductor and the capacitor.

10. The circuit of claim 1, wherein the reference voltage is half the voltage of the first positive rail voltage and the second negative rail voltage.

11. The circuit of claim 1, wherein the means for resonating the capacitor and the inductor further comprises:
a first positive voltage rail and a second negative voltage rail;
a pair of switches connected in series between the voltage rails, defining a stimulating voltage node therebetween;
the inductor being coupled to the stimulating voltage node and to the capacitor, the capacitor being configured in parallel with a first and a second lamp terminals; and
wherein the means for limiting the lamp striking voltage comprises:
the first diode and the second diode being connected in series between the voltage rails;
a first node being defined between the first and second diodes;
a third diode and a fourth diode being connected in series between the voltage rails;
a second node being defined between the third and fourth diodes;
the secondary winding further comprising a first end and a second end;
wherein the first end of the secondary winding is coupled to the second node between the third and fourth diodes; and
wherein the second end of the secondary winding is coupled to the first node between the first and second diodes.

12. The circuit of claim 1, wherein the means for resonating the capacitor and the inductor further comprises:
a first positive voltage rail and a second negative voltage rail;
two pairs of switches forming a full bridge between the voltage rails, defining a first and a second stimulating voltage node therebetween;
the inductor being coupled to the first stimulating voltage node and to the capacitor, the capacitor being configured in parallel with a first and a second lamp terminals and to the second stimulating voltage node; and
wherein the means for limiting the lamp striking voltage comprises:
the first diode and the second diode being connected in series between the voltage rails;
a first node being defined between the first and second diodes;
a third diode and a fourth diode being connected in series between the voltage rails;
a second node being defined between the third and fourth diodes;
the secondary winding further comprising a first end and a second end;
wherein the first end of the secondary winding is coupled to the second node between the third and fourth diodes; and
wherein the second end of the secondary winding is coupled to the first node between the first and second diodes.

13. A method for controlling a lamp striking voltage circuit having a desired peak lamp striking voltage, the lamp striking voltage circuit including a first positive voltage rail and a second negative voltage rail, a resonating circuit, the resonating circuit including an inductor, the lamp striking voltage circuit also including first and second lamp terminals, a pair of switches coupled in series between the voltage rails and configured to provide a stimulating voltage at a resonant frequency to the resonating circuit, the lamp striking voltage circuit further including a pair of capacitors coupled in series between the voltage rails and defining a first node therebetween, the method comprising:
providing a secondary winding, the secondary winding including a first end and a second end;
coupling the first end of the secondary winding to the first node;
providing a first diode and a second diode coupled in series between the voltage rails and defining a second node therebetween;
coupling the second end of the secondary winding to the second node;
wherein a voltage on the secondary winding is proportional to a voltage on the inductor.

14. The method of claim 13, further comprising the step of choosing the turns ratio of the inductor and the secondary winding such that at the desired peak lamp striking voltage, a peak secondary winding voltage is equal to half of the rail voltages.

15. The method of claim 13, further comprising the steps of providing a primary low pass filter and using the primary low pass filter to filter the stimulating voltage prior to providing the stimulating voltage to the resonating circuit.

16. The method of claim 15, further comprising the step of configuring the primary low pass filter with an inductor and a capacitor.

17. The method of claim 13, further comprising the steps of providing a first and a second low pass filters, using the first low pass filter to filter the stimulating voltage provided by the first switch prior to providing the stimulating voltage to the resonating circuit, and using the second low pass filter to filter the stimulating voltage provided by the second switch prior to providing the stimulating voltage to the resonating circuit.

18. The method of claim 13, further comprising the step of coupling the second lamp terminal to the second node.

19. The method of claim 18, further comprising the step of providing a monitoring device, the monitoring device being coupled to the secondary winding and configured to stop the stimulating voltage from being transmitted to the resonating circuit if a voltage of the secondary winding exceeds a reference voltage.

20. A circuit comprising:
a resonance portion;
a stimulating voltage providing portion configured to provide a stimulating voltage to the resonance portion;
a limiting portion, including a secondary winding and at least one pair of diodes.

21. The circuit of claim 20, wherein the stimulating voltage providing portion further comprises:
a first and a second lamp terminal;
a first positive voltage rail;
a second negative voltage rail;
a pair of switches coupled in series between the voltage rails;
wherein the pair of switches are configured to operate to produce the stimulating voltage;
wherein the resonance portion comprises:
an inductor configured to receive the stimulating voltage; and
a capacitor;
the capacitor being coupled to the inductor and being configured in parallel with a first and a second lamp terminals; and
wherein the limiting portion further comprises:
a first node defined between the first and second diodes, the pair of diodes being connected in series between the voltage rails;
the secondary winding further comprising a first end and a second end;
wherein the first end of the secondary winding is coupled to a second node held at half the voltage of the voltage rails; and
wherein the second end of the secondary winding is coupled to the first node between the first and second diodes.

22. The circuit of claim 21, wherein the second lamp terminal is coupled to the first node.

23. The circuit of claim 21, further comprising a first low pass filter and a second low pass filter, the first low pass filter configured to filter voltage from the first positive voltage rail before the voltage from the first positive voltage rail reaches the resonance portion, and the second low pass filter configured to filter voltage from the second negative voltage rail before the voltage from the second negative voltage rail reaches the resonance portion.

24. The circuit of claim 21, wherein a voltage on the secondary winding will forward bias one of the first and second diodes if the voltage on the secondary winding exceeds a value of half of the voltage of the voltage rails.

25. The circuit of claim 22, further comprising a primary low pass filter configured to filter the stimulating voltage before the stimulating voltage reaches the resonance portion.

26. The circuit of claim 22, further comprising a first low pass filter and a second low pass filter, the first low pass filter configured to filter voltage from the first positive voltage rail before the voltage from the first positive voltage rail reaches the resonance portion, and the second low pass filter configured to filter voltage from the second negative voltage rail before the voltage from the second negative voltage rail reaches the resonance portion.

27. The circuit of claim 22, further comprising a monitoring device coupled to the secondary winding, the monitoring device configured to stop the stimulating voltage from reaching the resonance portion if a voltage on the secondary winding exceeds a reference voltage.

28. The circuit of claim 20, further comprising a primary low pass filter configured to filter the stimulating voltage before the stimulating voltage is provided to the resonance portion.

29. A method for controlling a lamp striking voltage circuit including a pair of switches, a first positive rail voltage and a second negative rail voltage, the pair of switches connected in series between the first positive voltage rail and the second negative voltage rail, a pair of capacitors configured in series between the voltage rails, the switches configured to provide a stimulating voltage to a resonating circuit, the method comprising
providing a secondary winding, the secondary winding including a first end and a second end;
coupling the first end of the secondary winding to a first node between the series capacitors;
providing a first diode and a second diode coupled in series between the voltage rails;
coupling the second end of the secondary winding between the diodes;
wherein a voltage on the secondary winding is proportional to a voltage on the inductor.

30. The method of claim 29, further comprising selecting the turns ratio of the inductor and the secondary winding such that at the desired peak lamp striking voltage, a peak secondary winding voltage is equal to half of the rail voltages.

31. The method of claim 29, further comprising the steps of providing a primary low pass filter; and
using the primary low pass filter to filter the stimulating voltage prior to providing the stimulating voltage to the resonating circuit.

32. The method of claim 31, further comprising the step of configuring the primary low pass filter with an inductor and a capacitor.

33. The method of claim 29, further comprising the steps of providing a first and a second low pass filters;
using the first low pass filter to filter the stimulating voltage from the first switch prior to the stimulating voltage reaching the resonating circuit; and
using the second low pass filter to filter the stimulating voltage from the second switch prior to the stimulating voltage reaching the resonating circuit.

34. The method of claim 29, further comprising the steps of providing a pair of lamp terminals to the lamp striking voltage circuit;
coupling the first of the lamp terminals to the resonating circuit.

35. The method of claim 34, further comprising the step of coupling the second lamp terminal between the pair of diodes.

36. The method of claim 35, further comprising the steps of providing a monitoring device;
coupling the monitoring device to the secondary winding; and
configuring the monitoring device to disable the stimulating voltage if a voltage of the secondary winding exceeds a reference voltage.

37. The method of claim 36, further comprising the step of configuring the monitoring device to re-enable the stimulating voltage once a voltage of the secondary winding no longer exceeds the reference voltage.

38. The method of claim 30, wherein a voltage limited by the secondary winding and pair of diodes is diverted back into the voltage rails.
